(19) United States
(12) Patent Application Publication
(10) Pub. No.: US 2004/0266417 A1
(43) Pub. Date: Dec. 30, 2004

(54) Wirelessly programming memory devices

(76) Inventor: David Janas, El Dorado Hills, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/607,344

(22) Filed: Jun. 26, 2003

(51) Int. Cl. H04Q 7/00

(52) U.S. Cl. 455/419; 455/410

(57) ABSTRACT

In one embodiment, a method includes wirelessly programming a memory device with firmware code for a client device. The programming may occur during manufacture of the client device by establishing a wireless link between the memory device and a programmer. The client device may be a wireless device such as a cellular telephone, personal digital assistant, and the like.

### BACKGROUND

Nonvolatile memories such as a flash memory are programmed to store desired code and data in the memory. For example, a wireless device manufacturer using a flash memory in a wireless device may program the flash memory to include code, such as firmware, an operating system, boot software and the like, to operate the wireless device.

Programmers used to program such nonvolatile memories rely on a physical link between the programmer and the memory. Such physical links include a wired connection via a Joint Test Action Group (JTAG) interface, or insertion of the memory into a programmer, or coupling of a circuit board including the memory device to an on-board or in-system programmer. During high volume manufacturing, a bottleneck may occur at the programmer due to the physical relationship between the programmer and the memory device. Such a constraint limits manufacturing flexibility in terms of both space and time. A need thus exists to improve manufacturing flexibility with regard to programming memory devices.

### BRIEF DESCRIPTION OF THE DRAWINGS

FIG. 1 is a block diagram of a silicon module in accordance with one embodiment of the present invention.

FIG. 2 is a block diagram of a client device in accordance with one embodiment of the present invention.

FIG. 3 is a block diagram of a manufacturing environment in accordance with one embodiment of the present invention.

FIG. 4 is a flow diagram of a method for programming client devices in accordance with one embodiment of the present invention.

### DETAILED DESCRIPTION

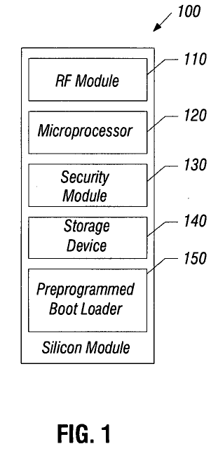

Referring to FIG. 1, shown is a block diagram of a silicon module in accordance with one embodiment of the present invention. Such a silicon module may be used, for example, in a cellular phone or other wireless device. As shown in FIG. 1, a silicon module 100 includes a radio frequency (RF) module 110, a microprocessor 120, a security module 130, a storage (i.e., memory) device 140, and a pre-programmed boot loader 150.

In one embodiment, RF module 110 may include an antenna such as a dipole antenna, helical antenna, global system for mobile communication (GSM) antenna or the like. RF module 110 may also include a wireless interface so that a wireless device including silicon module 100 may communicate wirelessly in accordance with a desired protocol.

Microprocessor 120 may be a general-purpose processor, a digital signal processor (DSP), or a combination thereof, in one embodiment. In other embodiments, a general-purpose or special-purpose processor may be coupled to a separate DSP via an internal bus. Microprocessor 120 (and a DSP, if present) may be coupled to memory device 140 and pre-programmed boot loader 150. Further, microprocessor 120 may be coupled to RF module 110 via a peripheral bus interface and a peripheral bus, in one embodiment.

Security module 130 may be a fixed or portable token and may be coupled to pre-programmed boot loader 150 and microprocessor 120. For example, an embodiment using a fixed token may include a general-purpose processor, an application specific integrated circuit (ASIC) or the like which is programmed to perform security operations including, for example, cryptographic operations and the like. In various embodiments, security module 130 may be used to confirm that trusted code is opened and executed from pre-programmed boot loader 150. Memory device 140 may be a nonvolatile memory, such as a flash memory, for example. Similarly, pre-programmed boot loader 150 may be a pre-programmed nonvolatile memory.

In one embodiment, the above components of silicon module 100 may be housed in a single package, while in other embodiments the components may be housed in separate packages. Further, while shown in FIG. 1 as having a separate memory device 140 and pre-programmed boot loader 150, in other embodiments the pre-programmed boot loader may be included as part of a single memory, such as a flash or other nonvolatile memory device.

In various embodiments, pre-programmed boot loader 150 may be a trusted boot loader seed pre-programmed into a memory device during device manufacture and testing, although the scope of the present invention is not limited in this regard. In such embodiments, boot loader 150 may be capable of initializing a microprocessor and RF module with which it is associated. In such manner, a wireless communication link may be established with a programmer to appropriately program an associated memory device. In one such embodiment, the programmer may be a head-end programmer to write code and data into the memory device.

In such manner, higher manufacturing throughput may be realized as a number of client devices (e.g., wireless devices) may be programmed simultaneously, in certain embodiments. Further, programming may occur while other manufacturing processes are being performed, such as steps occurring on an assembly line. Similarly, more flexibility may be provided to client devices for software customization, extensions, and bug fixes by allowing programming or reprogramming of nonvolatile memories at any time during a production or post-production life cycle.

In certain embodiments, programming may occur over-the-air (OTA) to deliver code. For example, code updates to a cellular phone including a silicon module in accordance with an embodiment of the present invention may be performed to update firmware, an operating system, or other programs of the cellular phone. In certain embodiments, security module 130 may be used to ensure that such updates are trusted (e.g., originating from a trusted source, such as a device manufacturer or service provider). Depending upon a service provider or user preferences, such updates may occur automatically or be initiated by a user. Alternately, a user may be advised that such updates are available and be given the option to choose to receive such updates.

Because in certain embodiments the boot loader may be seeded during manufacture of the memory device, better security may be provided, as trust can be established by the manufacturer of the memory device. In certain embodiments, NOR-based flash memories may be programmed competitively with NAND-based flash memories by wirelessly programming the NOR flash devices in accordance with an embodiment of the present invention.

While wireless communication protocols may vary in different embodiments, in certain embodiments wireless communication may occur in accordance with the Institute of Electrical and Electronics Engineers IEEE 802.11b standard, IEEE std. 802.11b-1999 (published Sep. 16, 1999) or 802.11g-2003 (published June 2003), a BLUETOOTH™ protocol, general packet radio service (GPRS), global system for mobile communication (GSM), code division multiple access (CDMA), a third generation mobile system (3GPP), a wireless JAVA™ community process (JCP) or the like.

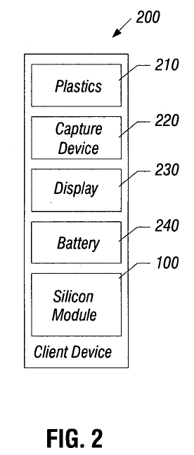

Referring now to FIG. 2, shown is a block diagram of a client device in accordance with one embodiment of the present invention. As shown in FIG. 2, client device 200 may include a number of sub-modules, including silicon module 100, plastics 210, a capture device 220, a display 230 and a battery 240.

In the embodiment of FIG. 2, silicon module 100 may be the same as discussed above with regard to FIG. 1. Plastics 210 may be a housing, buttons, and other components of the client device. In one embodiment, capture device 220 may be a digital camera. Display 230 may, in one embodiment, be a liquid crystal display (LCD) of the client device, and battery 240 may be a lithium ion (LiIon) or other rechargeable battery, in certain embodiments.

In one embodiment, a client device may be a cellular telephone; however the client device may be any portable device such as a personal digital assistant (PDA), laptop computer, or other device capable of wireless communication, in other embodiments. Further, while shown in the embodiment of FIG. 2 as including the above-described components, in other embodiments more, fewer or different components may be present.

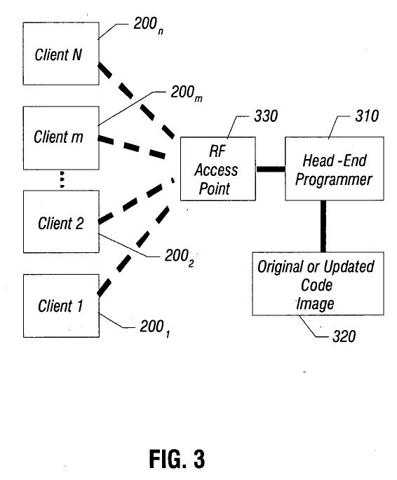

Referring now to FIG. 3, shown is a block diagram of a manufacturing environment in accordance with one embodiment of the present invention. The manufacturing environment of FIG. 3 may be, for example, a manufacturing facility of a cellular phone manufacturer. As shown in FIG. 3, a number of client devices 200_{1-N} may be present in the facility. For example, client devices 200_{1-N} may be present on an assembly line or other part of the manufacturing facility.

In various embodiments, a wireless link may be made between each of client devices 200_{1-N} and an access point 330. While such access point may vary, in certain embodiments the access point may be a wireless access point of a wireless local area network (WLAN) in accordance with the IEEE 802.11b or g specification. Alternately, access point 330 may communicate in accordance with another protocol such as BLUETOOTH™, CDMA, GSM and the like.

Still referring to FIG. 3, access point 330 may be coupled to a head-end programmer 310. In certain embodiments programmer 310 may be a personal computer (PC), server computer or the like. Programmer 310 may be used to provide programming instructions and code and data to access point 330 for communication to client devices 200_{1-N}. Such code and data may be stored in a storage device 320 which includes, for example, original or updated code images. In one embodiment, such a code image may be firmware required for operation of the client device. Such firmware may be, for example, an operating system for the client device. While shown in the embodiment of FIG. 3 as a separate element, it is to be understood that storage device 320 may be incorporated within programmer 310 as an internal memory. Such a storage device or internal memory may be any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), erasable programmable read-only memories (EPROMs), flash memories, electrically erasable programmable read-only memories (EEPROMs), magnetic or optical cards, or any type of media suitable for storing electronic instructions. Similar devices may be used for a separate programmer, such as a manufacturing programmer at a memory device manufacturer, to store instructions to program pre-programmed boot loader 150.

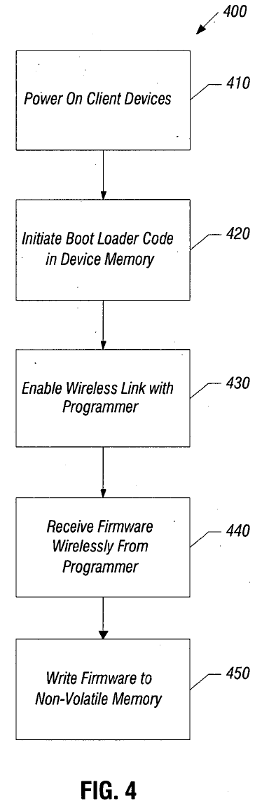

Referring now to FIG. 4, shown is a flow diagram of a method for programming one or more client devices in accordance with one embodiment of the present invention. By programming a plurality of client devices in parallel, scalability and flexibility of a manufacturing environment may be realized and/or improved. As shown in FIG. 4, method 400 may begin by powering on the client device(s) (block 410). For example, during manufacture of the client device(s), power may be provided to all or a portion of each device via a battery or connection to alternating current (AC) power available in the factory.

Next, boot loader code in a nonvolatile memory of the client device(s) may be initiated (block 420). For example in client device 200, pre-programmed boot loader 150 may include instructions to enable basic operation, including wireless communication, although no firmware has been loaded. In one embodiment, such boot loader code may be a trusted boot loader, as discussed above.

Next, a wireless link may be enabled between the client device(s) and a programmer (block 430). For example, in the embodiment of FIG. 3, a wireless link is formed between access point 330 and client devices 200_{1-N}. In certain embodiments, the wireless link may be a secure link. As discussed above, such a wireless link may be made using any one of a number of wireless communication protocols.

Firmware may then be downloaded to the client device(s) from the programmer (block 440). For example, in the manufacturing environment of FIG. 3, programmer 310 may send appropriate programming instructions and code and data to access point 330 for wireless broadcast to a plurality of wireless devices 200_{1-N} present in the manufacturing environment. In certain embodiments, such programming may occur in accordance with manufacturing programming techniques. Such techniques may include, for example, programming each memory location in a first phase; verifying the programming in a second phase; and reiterating the first and second phases if required, for each location. Finally, the firmware may be written to the nonvolatile memory within the client device(s) (block 450).

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
wirelessly programming a memory device with firmware code.

2. The method of claim 1, wherein the memory device is embedded in a client device.

3. The method of claim 1, further comprising wirelessly re-programming the memory device with modified firmware.

4. The method of claim 3, wherein wirelessly re-programming the memory device comprises sending modified firmware via an over-the-air transmission.

5. The method of claim 1, wherein the memory device includes a trusted seed.

6. The method of claim 5, further comprising using the trusted seed to validate the memory device before wirelessly programming the memory device.

7. The method of claim 1, further comprising wirelessly programming a plurality of memory devices in parallel.

8. The method of claim 7, wherein each of the plurality of memory devices is embedded in one of a plurality of client devices.

9. A method comprising:
programming a boot seed into a memory device, the boot seed including code to initiate a wireless link to receive virgin programming of the memory device.

10. The method of claim 9, wherein programming the boot seed occurs during production of the memory device.

11. The method of claim 9, wherein the code includes instructions to enable a processor coupled to the memory device to initiate the wireless link.

12. The method of claim 9, wherein the memory device comprises a nonvolatile memory.

13. The method of claim 9, wherein the virgin programming comprises firmware of a wireless device including the memory device.

14. The method of claim 9, wherein the boot seed comprises a trusted boot seed.

15. A system comprising:
a first storage device to store code to enable a wireless link to receive virgin programming of a second storage device coupled to the first storage device; and
a dipole antenna coupled to the first storage device.

16. The system of claim 15, wherein the first storage device and the second storage device comprise a single memory device.

17. The system of claim 16, wherein the single memory device comprises a flash memory.

18. The system of claim 15, wherein the code comprises a trusted boot loader.

19. An article comprising a machine-readable storage medium containing instructions that if executed enable a system to:
enable wireless communication of the system; and
wirelessly receive virgin programming of a memory device of the system.

20. The article of claim 19, wherein the virgin programming comprises firmware of the system, the system comprising a wireless device.

21. The article of claim 19, further comprising instructions that if executed enable the system to enable the wireless communication with a programmer via a secure link.

22. The article of claim 19, wherein the instructions comprise secure code stored in a portion of the memory device.

23. An apparatus comprising:
a first storage device to store code to enable wireless communication of the apparatus to receive virgin programming of a memory device of the apparatus.

24. The apparatus of claim 23, further comprising a processor coupled to the first storage device to execute the code.

25. The apparatus of claim 23, wherein the first storage device and the memory device comprise a flash memory.

26. The apparatus of claim 23, wherein the apparatus comprises a cellular telephone.

27. The apparatus of claim 26, wherein the cellular telephone lacks firmware until the virgin programming is received.
